(19) United States
(12) Patent Application Publication
(10) Pub. No.: US 2008/0149707 A1
(43) Pub. Date: Jun. 26, 2008

(54) BANK CARD MANAGEMENT SYSTEM

(76) Inventor: Alfred Urcuyo, Woodland Hills, CA (US)

Correspondence Address: ERICKSON & KLEYPAS, L.L.C., 800 W. 47TH STREET, SUITE 401, KANSAS CITY, MO, 64112, US

(21) Appl. No.: 11/875,825

(22) Filed: Oct. 19, 2007

Related U.S. Application Data
(60) Provisional application No. 60/862,063, filed on Oct. 19, 2006.

(51) Int. Cl. G06Q 40/00; G06Q 90/00

(52) U.S. Cl. 235/379

(57) ABSTRACT

A bank card management system includes software for real time tracking of card usage and real time reporting and allocation of commission payments to third parties based upon such usage.

### BACKGROUND OF THE INVENTION

The present invention relates to bank cards, such as credit cards and debit cards, that are issued to cardholders, such as individuals, business entities and organizations, and more particularly to a pre-paid and re-loadable bank card management system utilizing software to track and report all cardholder usage and allocate commission payments to multiple third parties in real time.

Systems for managing bank cards, including distributing and activating stored value cards, are known in the prior art. Such systems typically include an issuer such as a bank or other financial institution and a card provider such as MasterCard or Visa. The bank may issue cards to the consumer directly or through a third party distributor.

As disclosed in U.S. Pat. No. 7,093,761, the prior art further includes systems and methods for distributing identifier indicia to a merchant for distribution to a customer having a customer account. The identifier typically has an associated service value that is redeemable with a plurality of carriers. The method may further include activating the identifier upon distribution of the indicia to the customer. A central processor verifies whether the merchant is authorized to distribute the indicia to the customer. During distribution to the customer, the merchant may transmit prior transaction information to the central processor, and the central processor may reconcile past billing records based on such prior transaction information. Methods may also include receiving a request from the customer to add the associated service value to the customer account. Systems and methods used with various types of stored-value card accounts, including prepaid emergency road service cards, are included in the prior art.

The prior art further includes closed prepaid phone card systems that use activation terminals unique to the prepaid card issuer. U.S. Pat. No. 5,577,109 to Stimson et al. discloses such a closed system. In this system, the cards are not preactivated when stocked for distribution. Retail locations from which cards are sold are provided with a dedicated activation terminal, which allows the retail operator to set the value of the card at the time of the sale. The activation terminal connects to the card issuer's system to pass along the value amount and to request activation of the card. Depleted cards can be recharged or reloaded in the same manner as they are sold.

It would be advantageous, however, for a bank card management system to provide a means for real time usage tracking and reporting, real time allocation of commissions to a plurality of card distributors, and both closed and open systems for reloading cards.

### BRIEF SUMMARY OF THE INVENTION

A bank card management system includes a personal use card offered to customers, also referred to herein as cardholders, users, buyers, and purchasers, via retail locations, also referred to herein as distributors. The retail locations are typically independently owned and have a contract with the card provider, which may also be the system administrator. Cards are issued immediately upon setup of the account with an initial card being offered to the purchaser at the point of sale of the card and associated account. An embossed card is then mailed to the purchaser after the card is printed. The principal anticipated uses of the cards are to affect payment for goods and services and for international remittance. The system administrator rewards distributors and their representatives/agents with a share of the continuing revenues from the use of the cards sold by the distributor for the life of the card, even if the cardholder loads the card with additional funds at a location owned by a different entity from whom they bought the card.

Other advantages of the invention will become apparent from the following description taken in connection with the accompanying drawings, wherein is set forth by way of illustration and example an embodiment of the present invention.

### BRIEF DESCRIPTION OF THE SEVERAL VIEWS OF THE DRAWINGS

FIG. 1 is a diagram showing aspects of an embodiment of a bank card management system.

FIG. 2 is a diagram showing an overview of a bank card management system.

FIG. 3 is a diagram showing a method of pre-funding merchant terminals.

FIG. 4 is an illustration of a spreadsheet containing card numbers to be activated.

FIG. 5 is an illustration of a spreadsheet containing load amounts assigned to card numbers.

FIG. 6 is a table illustrating how token cost for various transactions.

FIG. 7 is a table illustrating fees assigned to transaction types.

FIG. 8 is a table illustrating how a transaction fee may be parsed among various entity levels.

FIG. 9 is a table illustrating how a transaction fee may be distributed among various entities that will each receive a commission as a share of the fee.

### DETAILED DESCRIPTION OF THE INVENTION

As required, a detailed embodiment of the present invention is disclosed herein; however, it is to be understood that the disclosed embodiment is merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

A system in accordance with the present invention may comprise a pre-paid and re-loadable bank card assigned to a customer account. Card management software records all transactions related to the card and associated account and tracks card usage on a world wide basis. The system provides for tracking and payment of commissions in real time to a plurality of distributors. The distributors facilitate sale of the bank cards and as well as loading the cards through system point of sale software. The point of sale software may run on VeriFone terminals, which are located across the United States, or equivalent information distribution systems.

In one embodiment of the system, a stored-value, prepaid bank card is issued by a bank to a customer, such as a party who has family abroad, missionaries, students, payroll, or government. All card products are secured in real time by merchant load facility owners (distributors) in the United States. All cardholder deposits are FDIC insured in the United States.

The end-user purchases one of several standard card packages containing at least one card from a distributor. The end-user will then register the card with the card issuer, or agent thereof, via the Internet or by calling a toll free telephone number printed on the back of the card. Due to requirements under the Patriot Act, no funds can be accessed or shared by the cardholder until they register. The cardholder may request that a card be issued to a family member in another country.

The system may be of particular benefit to citizens, or former citizens, from those countries wherein remittances from the United States are a significant component of the Gross National Product. These countries are typically interested in creating a more efficient and cost effective way for funds, particularly U.S. currency, to enter their country. Therefore, it may be particularly advantageous to employ the system in areas of the U.S. where the majority of those citizens who have immigrated to the U.S. now reside. After identifying those areas, the system administrator also identifies locations in the United States to become loading stations for the bank cards. A loading station is the location where the cards are sold and loaded. Typically, cards are sold to the loading stations by a distributor. Note that a bank card may be issued as a branded card through proprietary card loading software. Next, advertising is typically used to promote the loading stations via banners, flyers, billboards, radio and television.

Typically, the system administrator will perform the following functions:
Provide secure and convenient options for card offerings through issuers and distributors.
Provide ongoing research and development for card offerings.
Utilize just in time printing, packaging, shipping and systems integration.
Facilitate instant card loads.
Track program success and purchaser usage.
Utilize Patriot Act compliant due diligence and registration processes.
Configure the stored value card system to meet changing customer needs.
Provide financial institutions with a customized, fully integrated and secure web-based applications that can be quickly deployed to meet customer demands in real-time.
System administrators who access the system, both at the distributor and financial institution level, use the administrative and reporting systems to track program success, as well as access full card account reports.

For the consumer, the cards offer immediate access to funds. They can be conveniently purchased at merchant locations in their own community through proprietary loading software. The product is competitively priced with the strongest residual income plan for participating agents, reps and merchants. The secondary PIN Based UniBancard™ can be given to a relative or associate to use in the U.S. or abroad. Also, for a small additional fee they can upgrade their PIN Based Debit UniBancard™ card to the Signature Based UniBancard™ (Platinum MasterCard). With the signature based card, the card holder can sign for purchases. Purchase amounts are limited to the funds loaded on the card. With the PIN based card, every transaction conducted using the card requires entry of the associated PIN at the merchant establishment. The signature based card offers all the advantages of the standard stored value card, and it can be used at millions of merchants nationally and internationally where MasterCard debit cards are accepted.

For the participating merchant distributors, the system administrator provides residual income for the life of the card the distributor sold, even if it is loaded at another location. The system administrator rewards distributors and their representatives/agents with a share of the continuing revenues from the use of the cards sold for the life of the card, regardless of whether the cardholder loads the card at a different location from where they bought the card.

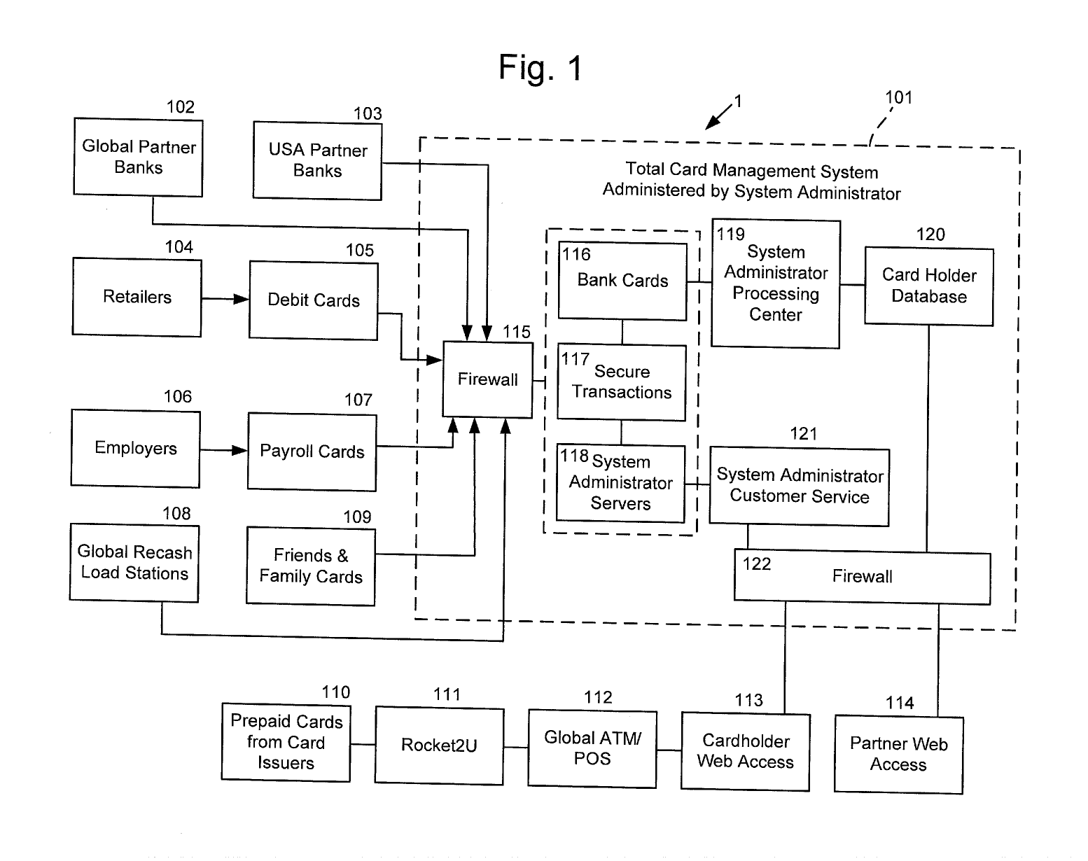

Referring now to FIG. 1 of the drawings, there is shown a bank card management system indicated by the reference numeral 1. Only selected elements of the system 1 are shown and described herein as it should be appreciated that certain aspects of a bank card management system are well known in the prior art. As illustrated, the system 1 comprises a system administrator processing center linking a card holder database to system administrator servers. Both the card holder database and the system administrator sever are linked to outside resources via the Internet and through a fire wall. The servers may be internally controlled by system administrator customer service. Global partner banks and/or US partner banks issue debit cards or payroll cards to retailers or employers, respectively. Cards are loaded at global recash load stations. Cardholder account access may be provided through the Internet, global ATMs and/or cell phone via services such as Rocket2U.

Elements of the system shown in FIG. 1, including the basic internal methodology of TCMS and external points of connection, are described as follows.

101—TCMS as a whole

102—Banks that TCMS can connect to for product issuance in foreign locations. Global Partner Banks communicate with the system via secure ftp. The system sends nightly flat files out to the SFTP site that the banks retrieve. Each bank moves funds on a nightly basis between the three accounts on hand at the bank. Each bank also can receive funds from other banks. To interact with other banks on the system network a bank opens an account for all other the banks on the network.

103—Banks that TCMS can connect to for product issuance in US locations. USA Partner Banks communicate with the system via secure ftp. The system sends out nightly flat files to the SFTP site that they retrieve and move funds on a nightly basis between the three accounts on hand at the bank. They also can receive funds from other banks. For every bank that becomes part of the network if the banks want to interact then all they have to do is open an account for all other banks on the network.

104—Retail establishments that are willing to sell our product and be a load station/merchant of CardMarte.

105—Debit Cards are the standard MasterCard/Visa Re-loadable cards that Retail Establishments sell.

106—Employers are the various employers that support our product by using our payroll card feature to pay their employees.

107—Payroll Cards are the cards these employers use to pay their employees and are governed by different laws.

108—Global Recash Loading Stations are stations that are able to load various products supported by TCMS through the Global Recash brand recognition.

109—Friends and Family Cards are the cards that can be requested by cardholders so that their family members can obtain a card too. Usually used in correlations to the card to card transfer feature.

110—Debit cards 105, payroll cards 107, friends and family cards 109 can all access the system 1 as prepaid cards from card issuers (e.g. MasterCard/Visa Cards) would through Rocket2U 111, Global ATMs/POS 112, Cardholder Web Access 113, and Partner Web Access 114 such as IVR and other 3rd parties.

111—Rocket2U is a feature that allows a cardholder to check their balance, conduct card to card transfers, and access their account using text messages.

112—Global ATMs/POS's are the numerous ways a cardholder can access their funds.

113—Cardholder Web Access is the online access point that allows a cardholder to view their account online.

114—Partner Web Access is simply Web Services that allow 3rd parties to talk to the system

115—Cisco Firewall

116—The account numbers kept on file in the system

117—The routing of transactions over a secure network (MIP, VAP, Maactor, Tec 01)

118—System Admin Servers (Web Servicers, Web Servers, and Web Cache)

119—Back End Operation Center for setting up accounts for cardholders to merchants to distributors. Also the place where you set up fees and commission distribution

120—Cardholder Information stored

121—Where customer service accesses the system to view cardholder information and assist with any issues.

122—Cisco Firewall

Each entity (104 and 106) is governed by its product. It can only do what its product allows it to do and comes with certain restrictions to communicate with the system. For example a retail terminal cannot do a direct deposit load but an employer can. So the products dictate the actions.

A retailer 104 can communicate with the system 1 using the hard terminal or the virtual terminal. This will allow it to do loads, activations, card balances, terminal balances and voids.

The employers 106 have the ability to do direct deposits to their cards. The debit cards can too but they carry lesser values and a retailer can't do it. It has to be an employer that conducts this. An individual can go to a retail establishment and buy a card and activate it. The individual can then take that card to his or her employer and have the employer direct deposit the individual's payroll on the card.

Global Loading Stations 108 use hard terminals and virtual terminals to access the system to conduct transactions that a retailer would. The Global Recash Partners can do it for numerous products that carry the Global Recash logo.

Friends and family cards 109 can reload at Global Recash locations 108 and can access the system to view their accounts via online or through the JVR. These cards mainly receive funds from cardholders of the other classification.

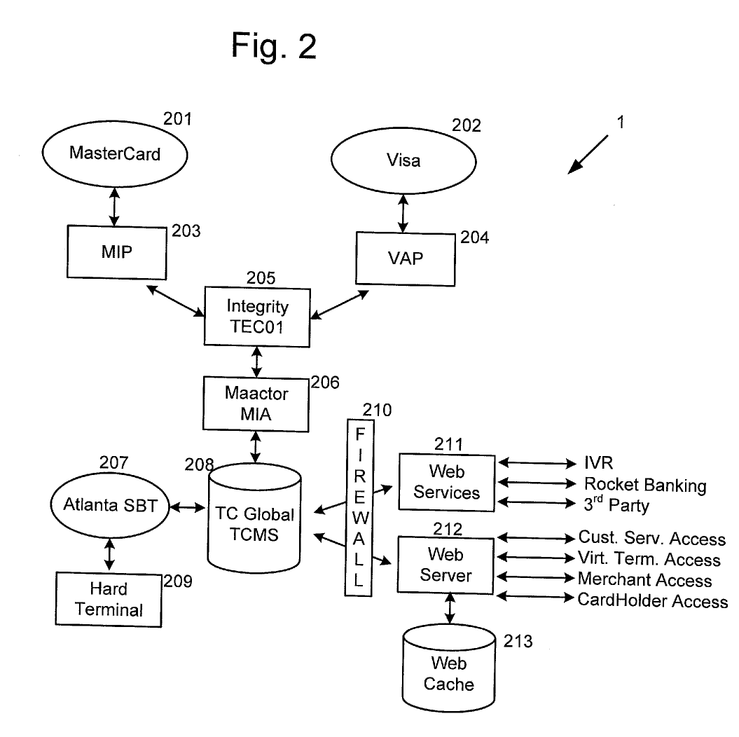

The Total Card Management System is a large system that is compromised of many components. The entire system is illustrated in FIG. 2 however for the duration of this document it will be split up into several pieces. When discussing the system as a whole it will be referenced as “The Total Card Management System” and when using the term “TCMS” it is only referring to the database that contains the information of the cardholders, merchants, and agents.

Elements of the system shown in FIG. 2 are described as follows.

201—Card Issuer A—The system at Card Issuer A (such as MasterCard) contains a router that identifies BINs and who the processor is for that card. It works similarly to a DNS server for internet sites. Once the transaction comes into Card Issuer A from a random processor it identifies the BIN and forwards the authorization request to the Processor which in this design is CardMarte.

202—Card Issuer B—The system at Card Issuer B (such as Visa) contains a router that identifies BINs and who the processor is for that card. It works similarly to a DNS server for internet sites. Once the transaction comes into Card Issuer B from a random processor it identifies the BIN and forwards the authorization request to the Processor which in this design is CardMarte.

203—MIP —Member Interface Processor—This is where the information that is sent from MasterCard is received by the system. The system must also send constant signals to MasterCard to ensure that the system is up and functioning.

204—VAP—VisaNet Access Point—This is where the information that is sent from Visa is received by the system.

205—Integrity TEC01—This checks the transactions integrity requirements by Visa and MasterCard. This is also the communication piece between the various internal Maactors. It also checks and validates the cvv and cvv2.

206—Maactor Mia—Checks card number and transaction type then routes to the TCMS database. Once the response is given the Macctor will route it back to its entry point to the Maactor.

207—Atlanta SBT—This is the center that receives all the transactions from the various Hard Terminals then routes them into Maactor via a VPN.

208—TCGLOBAL TCMS—This is the actual data base of the system that holds all the information of all the people out there and authorizes all transactions. For transaction processing this checks the balance, checks the AVS and creates the floating amount.

209—Hard Terminal—These are the physical terminals such as Verifone and Hypercomm that the system administrator places in Merchant Locations to conduct transactions such as Activation, Load, Card Balance, Terminal Balance, Card Unload, and Void.

210—Firewall—Cisco Firewall

211—Web Services—Have the services on DMZ with port 80 open to the network and only allows certain IP ranges, SSL and user passwords.

212—Web Server—Two ports published the 80 and 443 SSL port. This is used for internal processes while the external is the Web Services.

213—Web Cache—The storage of information that has come through the Web Services. This can hold information and be used to verify information without bogging down the system until the final item is needed such as balance for authorization for a card to card or whatever web item.

MIP, VAP, Integrity Tec 01, Maactor are all programs that exist in the processing flow that reside on their own servers within the system. ACH is an Automatic Clearing House. The ACH Network (hereinafter ACH) is a nationwide electronic funds transfer network which enables participating financial institutions to distribute electronic credit and debit entries to bank accounts and to settle such entries. ACH provides for interbank clearing of electronic payments for participating depository financial institutions. The process is governed by NACHA, The National Automated Clearing House Association. ACH operators, such as the Federal Reserve and the Electronic Payments Network, are central clearing facilities through which financial institutions transmit or receive ACH entries.

A BIN is a Bank Identification Number, i.e. the first numbers on the card that identify a card to the bank of issuance's processor for that BIN range.

A Hard Terminal is an actual piece of hardware that resides in a location to conduct transactions. Hypercoms, Verifones are all hard terminals. These terminals reside in all merchant locations that process credit cards. The system includes a program that can reside on a hard terminal that most locations have so they do not need to obtain a new terminal. It can function with their current one and not prevent them from processing.

An InterActive Voice Response System (IVR) is a computerized telecommunications element that receives incoming calls and directs them through a telephone system often using voice recognition and telephone keypad entry. It is often used in the banking industry.

Rocket2U is a feature of the Rocket Banking System that allows a customer to check their balance, conduct card to cards, and access their account using text messages.

With further reference to FIG. 2, the following processes may occur associated with the system:

Processing a transaction on a card that is being used at a retail location: The MasterCard information is sent from the processor of the merchant to MasterCard 201. MasterCard 201 then routes the transaction to the system based upon BIN number. The system 1 then takes the transaction through the MIP 203 into our system where the Integrity Tec01 205 verifies the integrity of the message. Once this is done it is sent to the Maactor 206 which is basically a system router. The Maactor 206 sees the message and forwards it onto the TCMS database 208. The TCMS database 208 checks card status and card balance then replies with an approved or decline based upon its results. The transaction gets routed back out the same way back to the merchant with the message of approved or declined.

Processing a Load/Activation/Card Balance/Terminal Balance/Void/Etc from a Hard Terminal The terminal creates a message and sends it to Atlanta SBT over phone line or Ethernet line. Atlanta SBT checks the integrity of message and forwards it on via VPN to the system to obtain approval or denial based upon the same variables stated in the previous section. The message is returned with an approved or denied message.

Processing a transaction from Web Services 211 or Web Servers 212: Web services 211 are used for external partners. Both come in with the same processes but with web services 211 the system verifies ID and IP to ensure that all messages are coming from the right partner. Once the transactions come in the external partners contact the database through the firewall and either create accounts, add funds, transfer funds, block accounts, or make inquiries. The Database responds with the response appropriate to the request.

### Cards

The Total Card Management System partially comprises an accounting program. It accounts for card accounts. The cards can be of several types including MasterCard/Visa Re-loadable Cards, MasterCard/is a Gift Cards, Payroll Cards, and Closed Loop Cards. Each card is attached to an account on TCMS 208. The account that the card is attached to acts very similarly to a bank account. It contains many of the same properties. The similarities increase greatly based upon the program that you is being discussed. Below is a quick outline of the properties of each card.

### MasterCard/Visa Re-Loadable Cards

1. Cardholder must register their card
2. Cardholder must have their information verified via OFAC and address verified as well.
3. Cardholder has the ability to conduct direct deposit to cards
4. Cardholder is able to re-load cards
5. Cards carry a maximum balance of $2500
6. Able to remit money using the card to card feature.
7. Able to remit money using the card to country feature.
8. Able to unload money from the card to a terminal.
9. Able to use PIN for ATM funds extraction
10. Able to use PIN for point of sale purchase
11. Able to use as a signature based card.

### MasterCard/Visa Gift Cards

1. Doesn't require registration
2. Card carries a maximum balance of $500
3. Does not get a PIN
4. Can only be used as a signature based card
5. May have some internet purchasing restrictions due to inability to conduct AVS since the card is not registered.

### Payroll Cards

1. Can only be loaded by an employer.
2. Card carries a maximum balance of $10,000.
3. Can conduct card to card transfers but cannot receive card to card transfers.
4. Card must adhere to State Labor Laws
5. A token system must be used to allow the cardholder to extract funds in a free and clear manner.
6. Card must be registered.
7. Funds from employer can be direct deposited onto the cards
8. Funds can be loaded onto the card using the employer's terminal.

### Closed Loop Cards

1. Card contains no flag of any major brand
2. Card is only able to be used at the locations designated on the card.
3. Maximum balance is to be determined by establishment selling the cards and CardMarte.

### Maestro/Star Card

1. Card has a Maestro or Star flag on it.
2. Maestro and Cirrus are PIN based cards
3. Cards are able to be used at ATMs
4. Cards are able to be used at PIN based point of sale locations
5. Card cannot be used online
6. Card carries a maximum balance of $2500
7. Direct deposit can be placed used to fund the card
8. Able to transfer money card to card
9. Able to remit money from card to country
10. Able to unload money from the card to terminal
11. Card must be registered
12. Card can be re-loaded
13. Cardholder must have their information verified via OFAC and address verified as well.

### Open Loop Stored Value Cards

Open loop stored value cards are issued with card association branding, and can typically be used anywhere the association brand is accepted. Examples include:
ATM Cards
Check Cards
Gift Cards
Payroll Cards
Teen Cards
Government Cards
Missionaries Cards
Remittance Cards
Student Cards
Health Insurance Cards
Pre-Paid Phone Card Integration
Pre-Paid Cell Phone Card Billing Integration
Card Billing Integration

Pre-Paid Phone Card Integration includes the following methodology for loading funds from a system bank card to a phone card. Each system bank card may be provided with a phone card number on the back of the system bank card and a dial in support number. The card holder will dial this number and define how much cash they would like to place on their phone card from their system bank card. This amount will be deducted from the system bank card account and then loaded on the phone card. The system grants the card holder a certain amount of time to call a location based upon cost per minute. The cost per minute is defined by region Once the transaction is complete, the amount will be settled that was actually used and any unused portion will be placed back on the system bank card.

With Pre-Paid Cell Phone Card Billing Integration, the system administrator is recognized by the telephone networks as offering a product to telephone network users, in a similar sense to ring tone vendors. In this case, a service of the card is offered by which a card holder's monthly fee for use of the card is added to the user's cell phone as a service sold by the system administrator.

### Closed Loop Stored Value Cards

Closed loop stored value cards are issued by a specific merchant or merchant group, and can typically only be used at that specific merchant or merchant group. Examples include:
Store Cards
Mall Cards
Gift Certificates
Gift Cards
Loyalty Cards
Health Insurance Cards

Both open loop and many closed loop stored value cards utilize existing processing networks. Consumers can spend up to the value loaded on the card account and can reload the card at any location where a symbol identifying a participating loading provider/location is seen. Loading may be offered by distributors or issuers, through counter service or through automated kiosk or equivalent means. Cards may also be loaded via the internet through a checking account or a credit card. The checking account typically must be verified prior to the allowance of this feature.

Electronic transfer of funds typically occurs through the Automated Clearing House (ACH) Network. An ACH transfer is requested from the cardholder's bank account and brought into the system and placed on the card once the ACH transfer is available and a minimum denial request time is allotted to prevent the cardholder from denying the transaction to his financial institution. The credit card may be loaded but it will typically need to be registered as a cash advance with the credit card company by the processor. Each distributor that wishes to add this feature supplies their own processor and will have to implement policies to manage its own chargeback issues. Once the card is processed, an approval message will be sent to the system via web services and the card will be loaded.

### Terminals

Currently The Total Card Management System uses several terminals and has created a program to be housed on the terminal that will communicate with TCMS to retrieve approvals and denials for various transactions. These terminals are standard credit card processing terminals that most merchants have throughout the world. The concept behind this was to create a program that anyone could download into their terminal and not interfere with their current programs thus avoiding the necessity of having an entity purchase a new terminal and lose valuable counter space.

The program is different from the current program on the terminal because the program on the terminal allows merchants to process credit cards. Now I will show how that connects to our system too but understand that our system is designed to work with the card programs listed in the previous section.

The terminals are able to communicate using either a phone line or an ethernet line. This line is directed toward the SBT terminal center in Atlanta from there the center directs all messages to Maactor in Miami. The Maactor then pushes the information to TCMS to attain approval or denial. The approval/denial message then is relayed back through the same channels back to the terminal.

The terminal is able to conduct several transactions. Those transactions are activation, load, unload, void, card balance, and terminal balance. The table below shows each transaction and its definition of usage.

| | |
|---|---|
| Activation | An ‘Activation’ lets the system know that |
| | this card is officially recognized on the |
| | system. |
| Load | A ‘Load’ is what allows money to be |
| | placed on the card. (Generally a terminal |
| | load cannot be done to an inactive card. A |
| | card must be activated prior to attempting a |
| | load. In this system, every time a load is |
| | done it carries with it an automatic check |
| | for activation. If the card is not active then |
| | load will force the activation immediately |
| | so that the terminal will not receive a |
| | rejection due to an inactive card.) |
| Unload | An ‘Unload’ transfers money from the card |
| | back to the terminal. |
| Void | A ‘Void’ is used to reverse the very last |
| | transaction conducted on the terminal. |
| Card Balance | ‘Card Balance’ is done to give the |
| | cardholder the balance on their card. |
| Terminal Balance | ‘Terminal Balance’ is the method that a |
| | merchant can use to see how much funds |
| | they still have available to load on cards. |

Terminal Balance indicates that a terminal can only carry a certain amount of money. A terminal has a reserve balance. There are two methods for attaining a balance. The more typical way is referred to as the pre-funding method. An alternative way is the post-funding method.

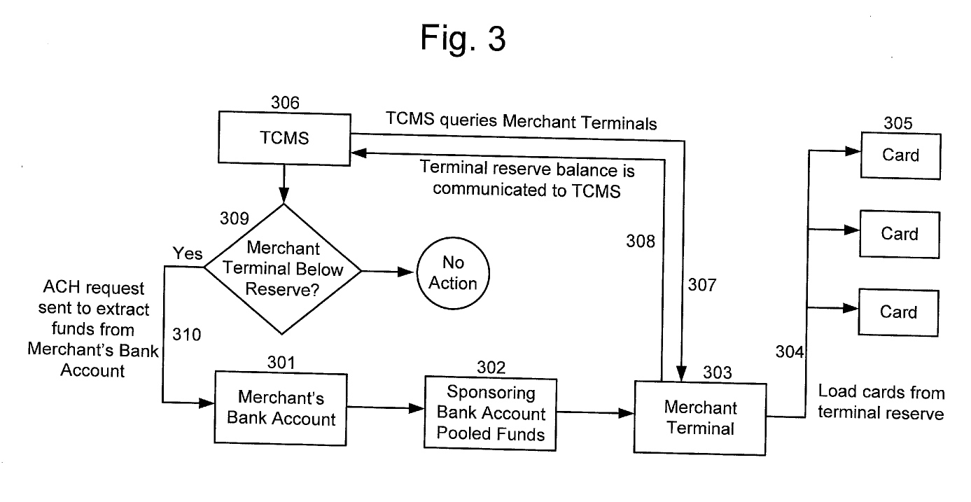

The pre-funding method (FIG. 3) takes funds from the merchant's bank account 301 via ACH and places them in an account 302 at the sponsoring bank of the card program. That amount is then recognized on the merchant terminal 303. The terminal 303 is now ready to load funds 304 on to a card 305. Each night the Total Card Management System 306 checks 307 the balance on the all the terminals 303 and determines 309 whether each terminal 303 is below the terminal reserve set for it. If a terminal 303 communicates 308 that it is below the reserve due to a transaction that occurred that day then an ACH request 310 will occur to extract the funds from the merchant's bank account 301. The funds will be placed in the bank account 302 at the sponsoring bank again and then noted on the terminal 303. This process can take anywhere from one to four days based upon the settings dictated for each merchant.

The post-funding method works in a similar way except the initial amount that is available on the terminal 303 is a credit. The process after that remains the same as for the pre-funding method.

To ensure the security of each terminal, the terminal program can only be downloaded if your terminal serial number is recognized on the terminal download center at SBT in Atlanta. As for the transactions, each transaction sends the serial number that the terminal contains and it also sends the terminal identification number assigned to that terminal with every transaction. If the information that is received is not correct then the transaction will be declined. The system is also able to lock out transactions so that they can only come from a certain IP address to avoid the Terminal Identification from being stolen and attempted to be replicated elsewhere. Also the terminal has user identifications and passwords so that only people that have user ID's and passwords can access the terminal.

### Virtual Terminal

The virtual terminal works exactly the same way the regular terminal works except there is no equipment. The virtual terminal is online. A web address is provided and a terminal identification number, user id and password must be provided to access the terminal. Once inside the terminal, everything works the same except for the activation feature. On the virtual terminal if a card is queried that is not active then the system forces it into an activation screen. Once the card is active then all other transactions are available to conduct.

A receipt is still available for printing using the printer connected to the computer. After each transaction a receipt appears on the screen that can be printed and kept by the merchant for records and also given to the cardholder for their records.

One of the unique features about the virtual terminal is its ability to handle multiple loads and multiple activations via a file being uploaded to the virtual terminal. The file loading function enables a merchant to load an excel spreadsheet to the terminal. The terminal then takes the file and saves it to the system so that it can be edited, calendared for action and reviewed when the merchant wants.

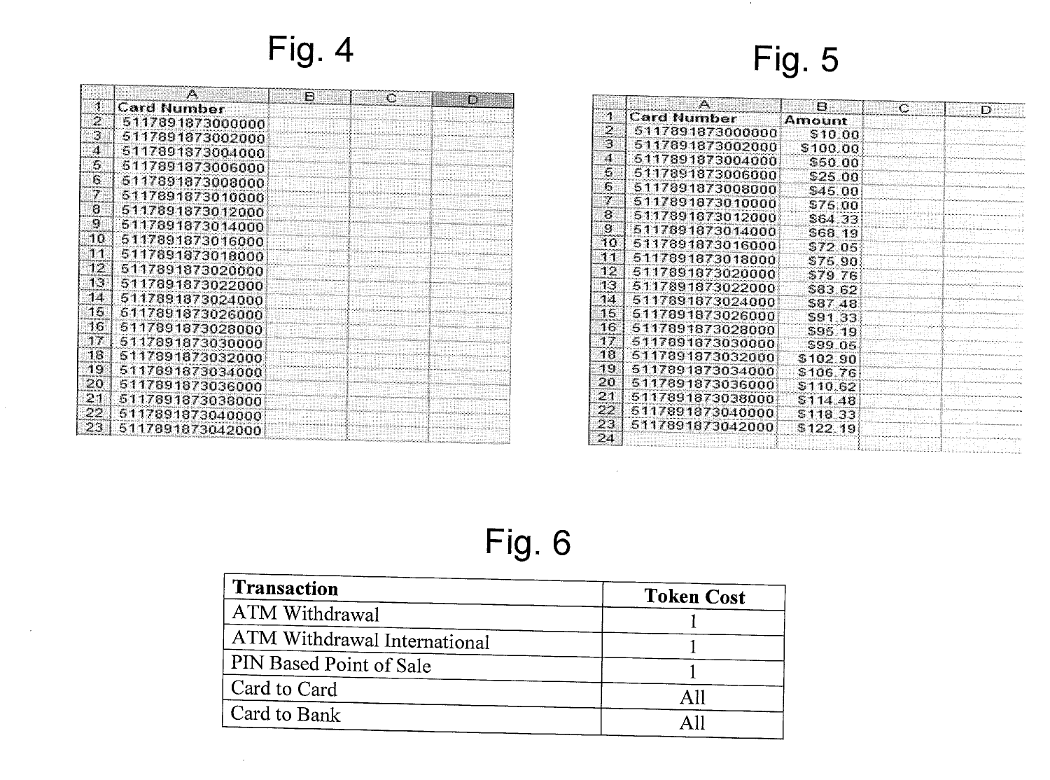

Examples of files used for activation and load are shown in FIG. 4 and FIG. 5, respectively. FIG. 4 is an illustration of a spreadsheet file containing card numbers corresponding to cards that are to be activated. Activation of the cards is facilitated by uploading the spreadsheet to a virtual terminal. FIG. 5 is an illustration of a spreadsheet containing load amounts assigned to card numbers. The spreadsheet is uploaded to a virtual terminal where the spreadsheet data is read to facilitate loading the card accounts with the cash amount specified in column B (for example) of the spreadsheet.

### Card Programs

### Personal Spend Card

The Personal Spend Card Program was first created to give people instant issued MasterCards that were non-personalized over the counter. A customer could go into a store and purchase the product and load money on the card. These cards would have to be registered and Patriot/OFAC approved prior to the removal of funds. Once the cards were activated and registered with approval then the cards could be used to load up to $2500 and conduct numerous transactions.

In the package of each card would contain a PIN number and a pass code, the pass code is used for accessing information over the web and over the IVR. The PIN number is used to withdraw funds from an ATM or to be used at a point of sale terminal.

Also, once the card was registered then a personalized MasterCard would be sent out to the cardholder's address that would replace the non-personalized over the counter card that the customer purchased. All the information such as registration and balance would be transferred to the new card. The other card would become de-activated and could be disposed of.

### Payroll Card

The other major card program is the Payroll Card Program. The Payroll Card Program was designated to enable employers to pay their employees on cards versus checks or cash. However due to State Labor Laws there are things that must be observed. These laws are referred to as the “Free and Clear Laws”. The “Free and Clear Laws” state that each employer must be able to pay their employees in a manner that does not have them pay for the right to extract their funds. It also states that the employees must be able to extract all of their funds.

The payroll program that was created on the system was done so to enable the cardholders to still adhere to these laws by developing a system of tokens. The tokens are a method for freebees. What they do is provide one token for every $300 increment that is received by the cardholder. That enables the cardholder to extract funds from an ATM for free. However these tokens also allow him to do a Pin Based Point of Sale transaction for free as well. The tokens can be used for several transactions, however once they are used then the fees will begin to be accessed.

FIG. 6 is a chart that shows how tokens are used and how a person might be able to extract funds from a card at no cost. For this example, the salary is $600 and two tokens have been earned.

Certain laws require the system administrator to give credit based upon information that is received by the Maactor. The Maactor will take the information of the location and process it. If the transaction comes from a certain known place then a credit could be applied instantly for the amount of the transaction.

For example, if a cardholder has $300 on their payroll card then they have the option to go to the USPS and purchase a money order using their PIN based point of sale. The transaction will extract all the funds from the card placing it on the money order. The cardholder will pay an out of pocket cost of $0.95 per money order. Once the system recognizes that Merchant Code used was for the Post Office and was for the entire amount on the card then the system will automatically credit the cardholder $0.95 to their card.

Another version includes the ability to turn any ATM system into a system sponsored ATM system. The system administrator does this by having The Total Card Management System recognize the codes for the ATMs that the system administrator is sponsoring and any time the code appears the system credits back the amount for the ATM cost plus the system does not charge the normal ATM fee.

The fee is calculated by assuming that most ATMs in the USA offer increments of $20. The system computes in forms of $20's and anything over is the cost for the ATM transaction. Example: If a cardholder goes to an ATM sponsored by the system and asks for $40 to be withdrawn, the ATM system then dials into the network it's affiliated with and it routes the system 1 card number via BIN to either MasterCard or Visa depending upon the product. The request for an ATM withdrawal will come in, for example, as $42.95. The ATM has banked its cost in already. The system will then approve the transaction. The message will relay back in reverse. The cardholder will receive the money. The cardholder's reports will show he withdrew $42.95. His balance will immediately show that he has been charged $2.95 by the bank and $2.50 by the system 1. However once the transaction is complete then the system 1 will immediately post back to the cardholder's account $5.45 to account for the ATM withdrawal fee and the system 1 fee. This will make ATM's free at any location that selected by the system administrator.

### Fee Structuring and Creation

The system administrator has created a system that will allow creation of a fee for any transaction that comes across a card and create the distribution of that fee instantly. The commission can be distributed as many times as desired. The commission can be divided into multiple parts. The division of the commissions is typically limited to one cent per line. Therefore, by dividing $2.50 into one penny per line 250 lines of commissions could be obtained.

First, the entities are created on the system. Each entity must contain certain information, typically including general information, such as: Name, Company Name, Address, Phone Number, Tax ID or SSN, eMail address, and bank information to receive commissions.

Once all the entities have been entered into TCMS then the structuring of fees and commissions can begin. The first thing to be created is typically the fees. Each transaction that the system can conduct contains a transaction code. That transaction code can be related to a certain fee. For example, a card to card transaction has a transaction code of 000001. The transaction code 0000001 has a fee associated with it. That fee is definable. Once all the transaction codes have fees associated with them (the fee can be zero), the system administrator can then create the structure for distribution of these fees.

The lines used are based upon the project. It is then determined what amount each line will get for commission on the various transactions. Once the commissions for all the lines have been divided, the line is assigned to an entity.

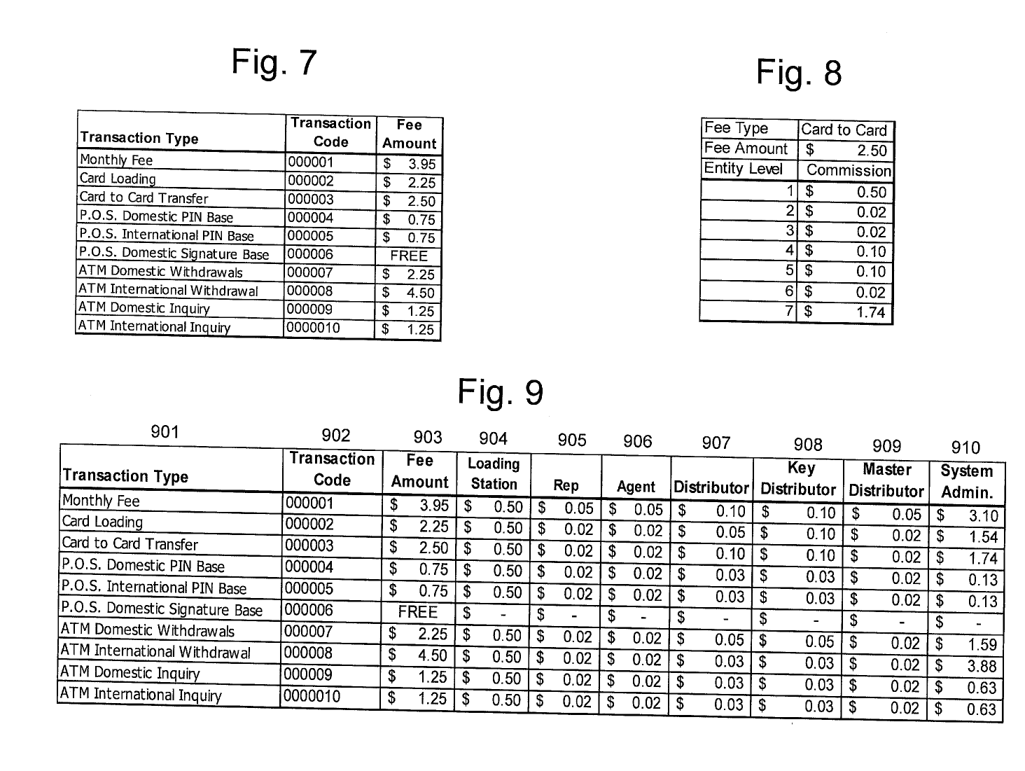

FIGS. 7 through 9 illustrate fee creation, fee distribution and distribution tree creation along with commission payouts according to hierarchy. In FIG. 7, the transactions that are available per product are attached to a fee to conduct each transaction. The transaction code and transaction type are typically static within this system table with only the fees being later added.

In FIG. 8 the fee is parsed out to numerous entity levels corresponding to entity commissions. Each line/level will receive in commissions the amount stated for the transaction being conducted. This will need to be done for each transaction that carries a fee.

FIG. 9 shows the assignment of these lines/levels. Columns 904 to 910 are headed by names of all the entities in the system, i.e. Loading Station, Rep (Representative), Agent, Distributor, Key Distributor, Master Distributor, System Administrator As shown, the transaction fees developed in FIG. 7 and parsed into commission levels in FIG. 8 are assigned to entities, each entity being assigned a level and corresponding commission from FIG. 8. Transaction fees are collected in real time as the transaction occurs and are also distributed to entities per the distribution scheme in FIG. 9 in real time. Using a username and password, or equivalent or other appropriate access means, a participating entity such as a distributor or loading station may access their account through the system 1 and view commissions received and distributed to the entity during the commission-generating transaction. Such commission distribution occurs automatically and upon collection of a transaction fee from the cardholder during a transaction.

### Advantages

Additional system features related to the stored value card product include:
Two proprietary front-end gateways
Integrated back-office interface: The Integrated back office interface is a method for other, external systems to integrate with the system of the present invention using web services. These web services create call methods that allow the system to perform the same functions that would be needed to be done if a party logged into the system using system direct interfaces. For example, an interface using back end integration can be made on a distributor's website to ask for cardholder registration information. This information would be sent to the external system through a SOAP interface to the system backend that would register the card and return an approved or declined response.
Support for multiple co-brands: The system can support multiple co-brands of distributors and of networks. A co-brander as defined by banking standards allows the system to create a product for a distributor that has their logos and individual product codes incorporated into the 16 digit card number. Through this the system administrator is able to define by range which cards belong to which distributor/co-brander. Sometimes co-branding can be referred to as multiple logos of the networks. For example, a party can have a MasterCard product that is supported by Maestro, Cirrus and Star. This card, depending upon the transaction conducted at the store level and it's processor, will route the transaction through it's normal system and based upon its decision will arrive at the system MIP or VAP depending upon the marks. From there the transaction goes through its normal course of approval and denial.
Flexible fee options for issuer and end-users: Each distributor can design their own cost structure. This cost structure is the fees that are related to the cardholder. The system administrator has certain fees that it must pay for each transaction so the fees created by the distributor will not fall under those costs unless another agreement is reached with the system administrator. Once the fee is created by the distributor then the distributor has in its possession a certain amount of profit that it can distribute to either the merchant/loading stations or any other entity that may have assisted in finalizing a deal.
Customizable email notifications: Each of the system cardholders are asked to supply an email address if they have one. If they do supply an email address then the system is able to send out an email to each cardholder or just a section of cardholders that may include notifications of new products, deals, or system updates/outages.
Payment gateway support and integration: The system administrator is able to have any of its MasterCards or Visa cards run through the system to obtain an approval based up on the routing of the transaction of the processor and the direction by MasterCard/Visa that states the BIN looking to be approved belongs to our system. The transaction would get routed to our MIP or VAP then go through a standard approval process. Also, the system administrator has an ability to use the unload feature at merchants/loading stations. This will avoid the MasterCard rails and strictly come to the system without any external processor. The funds attempting to be processed will either be approved or denied based upon available balance and then the funds will be extracted from the card and place on that merchant/loading station's terminal.
128 Bit Secure Sockets Layer (SSL) encryption provides secure Internet communications for consumer sessions.
VPN and PKI systems integration: A virtual private network is used by the SBT center in Atlanta that takes the information from the hard terminals and relays it to the system directly into the system Maactor. It operates the same as a gateway into the Maactor like the MIP/VAP and Tec01. Anytime anyone attempts to use this form it is because they are unable to use standard gateway features like the SOAP interface.
Multiple language support.
Integrated card management and customer support: Card Management and Customer Support can be integrated using the same SOAP interface and web services for back end operations. A client can create their own CM/CS screens and integrate with our system using these various functions. They can block lost or stolen cards, change pass codes, request pins, request cards for friends and relatives and so on.

### Advantages

Financial institutions that utilize the system to offer their customers stored value products will recognize numerous and long lasting benefits including:
Multiple affinity brand opportunities. The system administrator will allow the financial institution to market the production to various entities that can place their logos on the cards and choose the networks they would like to be associated with.
Strengthened relationships with current individual bank customers.
Enhanced ability to attract new customers.
Opportunity to use cards associated with the system to serve as an acquisition tool for customers who do not qualify for traditional credit card products. This is a customer acquisition tool. This would market the unfavorable credit risks and once the financial institutions see a proven track record of acceptable activity then they can market towards the consumer for a traditional credit card if they feel the client is worth the risk.
Create a new stream of incremental and recurring revenue. By creating the fees that it wishes to charge and the distribution of this fee as commissions to various entities then it will make a profit based upon its commission distribution. This will be there for the life of the card as long as the cardholder uses is and there is money to be extracted for the monthly fees.
Increase financial institution asset value.
Generate more loans from new deposits.
Receive Interchange profits. The percentage that is charged to merchants to process cards is sent to the sponsor of the card as earnings. For every card of the system that is processed, the financial institution will receive this money and will split it with the system administrator based upon the deal that is struck with each institution.
Strengthen relationships with current merchant bank customers.
Capture millions of dollars in un-banked deposits. The financial institution that sponsors this product will receive deposits via merchants for terminal funding and by cardholders through card loading.

Merchants that issue and accept stored value products introduce a compelling new payment vehicle that enhances customer service, loyalty, residual incomes and sales opportunities:
Strengthen relationships with existing and new customers.
Provide customers with an appealing electronic gift certificate or store credit option. Returns may now be processed as card loads. Cards can be given to the clients to use in the store. This can also be used to give gift certificates for the customers.
Reduce paperwork and bookkeeping. Less cash on hand and easy reporting through the system to account for the funds.
Provides a way to purchase goods without having a credit card or checking account
Build a portfolio of loyal card customers that provide a residual income through transactional use. The merchant receives commissions on the cards transactions. The system administrator also charges a monthly fee for this card. The merchant will receive commissions for that as well. The monthlies will continue to occur for the life of the card as long as funds are available to process the monthly.

By using or participating in the system, an enterprise will typically lower costs substantially. Costs to print and purchase checks and re-issue lost checks. In addition, the escheat procedure is avoided. Employers who use employee card accounts to distribute compensation may realize the following advantages:
Decrease payroll distribution cost, i.e. costs to print and purchase checks, re-issue lost checks, and costs associated with the escheat procedure.
Integrates with current payroll process.
Rapid card issuance for new employees.
Simplifies bank account reconciliation. The system has numerous reports to explain the loading of funds to cards and where each individual amount went and how much in total was used per payroll period.
Eliminates costly paper checks.
Eliminates lost check problem.
Eliminates check fraud losses.
Eliminates employees not cashing their check.
Eliminates lost check cancellation cost.
Simplifies payroll issues during travel.
Expense tracking at employers finger tips. If the employer is using it as an expense account then there is a duality ownership to the card. The card is under the cardholder's name but at the issuance of the employer. The employer can see how its employee spent the allotted funds for a trip, for example.
Employee rewards programs.
Profit sharing.
Eliminates ESCHEAT processing: no more need to turn in a check that was never cashed after the required time frame. As soon as money is placed on the card the cardholder has access. The same as if a direct deposit was conducted. The ESCHEAT procedure is eliminated.
Employee retention by offering a benefit to employees. The system administrator offers a card for use in payroll deposit. In some organizations, the employees cannot readily obtain a bank account.
Ability to select from a larger pool of potential employees due to more attractive benefits drawing more applicants.
Provides employees a secure and convenient way to get their pay.
Provides an additional employee benefit at no additional cost.

Employees who use employee card accounts to receive compensation from participating employers may realize the following advantages:
Funds are available immediately upon deposit in the card account.
Eliminates carrying large sums of cash
Secure PIN based Stored Value card.
Cash available at ATMs world-wide.
Employees can access their account online or via phone.
Employees do not need to be present at employer location to collect paycheck.
Ability for employees to make purchases.
Employees no longer perceive need to utilize services that charge high check-cashing fees.
Cash-back at grocery stores and many other merchant locations.
Free point of sale (POS) purchases in certain instances. The system administrator does not charge the cardholder to use the card when they use the signature based portion of the card. When they enter their PIN then a charge by the system administrator may be assessed.
Money in card account is safe if the card is lost or stolen
Employee money is FDIC Insured
The ability to have a credit card without a credit check or Social Security number.
Eliminates the need to go to Western Union, Money Gram or local country remittance sender.
Eliminates paper work typically required for money remittance.
Creates means for tracking expenses in real time.
Companion cards can be issued for any family member. This allows the employee to share funds at their discretion, with a simple click or call, or through employer facilitation at no cost to the employee or employer.
System administrator will typically support the program with promotional and instructional materials in English and Spanish, with additional languages upon request, to help employer notify, enroll and educate employees.
On-going support by a representative of the system administrator to help employer manage payroll card program by enrolling employees, generating PIN's, distributing cards, and providing ongoing customer and employee support.

It is to be understood that while certain forms of this invention have been illustrated and described, it is not limited thereto except insofar as such limitations are included in the following claims and allowable equivalents thereof.

Having thus described the invention, what is claimed as new and desired to be secured by Letters Patent is as follows:

1. A bank card management system comprising:
means for real time usage tracking
means for real time usage reporting
means for real time allocation of commissions.

2. The bank card management system of claim 1 wherein said commissions are derived from transaction fees charged to a card holder.

3. The bank card management system of claim 1 wherein said commissions are allocated to a plurality of entities.

4. The bank card management system of claim 1 wherein a transaction fee is subdivided into a multilevel fee distribution.

5. The bank card management system of claim 1 further comprising a closed system for reloading a bank card.

6. The bank card management system of claim 1 further comprising an open system for reloading a bank card.
